(19) United States
(12) Patent Application Publication
(10) Pub. No.: US 2017/0311740 A1
(43) Pub. Date: Nov. 2, 2017

(54) MOUNTING DOCK FOR A DISPLAY FRAME

(71) Applicant: REVOLUTION'R, Saint Julien Chapteuil (FR)

(72) Inventor: Alain LEROUX, Chaspinhac (FR)

(73) Assignee: REVOLUTION'R, Saint Julien Chapteuil (FR)

(21) Appl. No.: 15/140,128

(22) Filed: Apr. 27, 2016

(51) Int. Cl. A47G 1/17; F21V 23/02; F21V 21/108; F21V 23/06; A47G 1/14; A47B 97/04; A47B 23/04; A47G 1/16

(52) U.S. Cl. CPC A47G 1/17; A47B 97/04; F21V 23/023; F21V 21/108; A47B 23/04; F21V 23/06; A47G 1/142; A47G 2001/147; A47G 2001/1673

(57) ABSTRACT

The present invention relates to a mounting dock for the display frame of a document or picture, able to be affixed to a support wherein said mounting dock comprises one or several magnetic means intended to hold the frame pressed to said dock in the horizontal position, said magnetic means being engaged in at least one housing made in the dock and retention means intended to support the frame in the vertical position.

### BACKGROUND OF THE INVENTION

### 1. Field of the Invention

The technical scope of the present invention is that of systems to arrange display faces such as canvasses on which a painting may be made.

### 2. Description of the Related Art

Patents JP-2004305723 and U.S. Pat. No. 3,031,799 are known in which a U-shaped magnetic circuit is embedded into a supporting wall and cooperates with a metallic plate affixed to the rear side of a picture. The picture may thus be hung on the wall.

U.S. Pat. No. 8,113,476 is also known in which a picture may be hung by a hook affixed to a supporting wall by means of a metallic wire affixed to the rear of the picture and guided by a guiding element incorporating a magnet. This guiding element is mounted able to pivot at the end of the hook.

One technical drawback, however, lies in the fact that these systems for hanging pictures are relatively difficult to implement and above all do not allow for the easy exchange of the display faces.

### SUMMARY OF THE INVENTION

The aim of the present invention is thus to overcome these drawbacks of prior art by supplying a simplified structure for fixing a display face that is, for example, in the form of a painted canvas, a display panel, a printed photograph or a mirror.

The invention thus relates to a dock to receive a display frame for a document or picture, able to be affixed to a support, wherein it comprises one or several magnetic means intended to hold the frame pressed to said dock in the horizontal position, and retention means intended to support the frame in the vertical position, said magnetic means being engaged in at least one housing made in the dock.

According to one characteristic of the invention, the retention means are constituted by two lugs protruding with respect to the dock, arranged substantially in the vicinity of the magnetic means and at a distance from one another.

According to another characteristic of the invention, the dock incorporates two housings intended to each house magnetic means.

According to yet another characteristic of the invention, the dock incorporates a housing in its central part intended to house magnetic means.

According to yet another characteristic of the invention, the dock is constituted by a solid body in which housings are made to accommodate the magnetic means, and a plate to mount it on the support, the retention means protruding with respect to the body, the body and the dock being clipped and/or screwed together.

According to yet another characteristic of the invention, the body comprises two through slots, the mounting plate comprising two arms intended to cooperate with the though slots.

Advantageously, the arms end in body hooking claws.

According to yet another characteristic of the invention, the body is in the form of a U-shaped extrusion delimiting a cage acting as a single housing for the magnetic means and of which the free end of each branch is extended by feet parallel to the base of the U thereby defining an open space, each of the branches being provided with a longitudinal groove opening towards the exterior of the U.

According to yet another characteristic of the invention, the magnetic means are arranged in the U and held in position by the feet.

Advantageously, the magnetic means are constituted by two magnets kept at a distance from one another by a spacer.

Advantageously again, each magnet is wedged against the spacer by means of a cap.

According to yet another characteristic of the invention, the retention means are constituted by two lugs protruding with respect to one of the branches.

According to yet another characteristic of the invention, the dock comprises:

lighting means comprising an arm extended at its free end by a lighting device and incorporating at its other end a male part intended to engage in the groove in one of the branches, and

an electrical energy supply equipped with a male part intended to cooperate with the groove in the other branch,

electrical connection means being provided to link the lighting to the supply.

Advantageously, the connection means are in the form of a conductive wafer.

Advantageously again, the body is provided with a blind hole containing a spirit level to check the horizontal positioning of the dock.

A first advantage of the present invention lies in the fast and simple hooking and unhooking of the frame affixed to the dock.

Another advantage of the present invention lies in the easily reversible horizontal and vertical positioning of a display frame.

Another advantage of the present invention lies in the attachment of the dock, by any user, without the need for complex tooling and manipulation.

Yet another advantage of the present invention lies in the capacity for the frame to be held in position and centered with respect to the dock.

### BRIEF DESCRIPTION OF THE DRAWINGS

Other characteristics, particulars and advantages of the invention will become more apparent from the additional description given hereafter with reference to the appended drawings, in which:

FIG. 1 shows an exploded view of one embodiment of the dock according to the invention with its different components,

FIG. 2 shows a perspective view of the body of the dock according to the invention without the magnetic means,

FIG. 3 shows a cross section view of the body of the dock via a retention means,

FIGS. 4a-4c respectively show a view of the front face, the top and the rear face of the mounting plate according to the invention,

FIG. 5 shows a perspective view of the dock assembly according to the invention,

FIG. 6 shows a section view of the dock according to the invention via a cap,

FIG. 7 shows a front view of the dock according to the invention provided with a frame,

FIG. 8 shows a front view of the dock according to the invention provided with a spirit level,

FIG. 9 shows a cross section view via the bar of a lighting means assembled with the body according to the invention,

FIG. 10 shows a perspective view of lighting means partially assembled with the body according to the invention,

FIG. 11 shows a perspective view of the energy supply partially assembled with the body according to the invention,

FIG. 12 shows a front view of the energy supply according to the invention,

FIG. 13 shows a perspective view of the energy supply according to the invention, and

FIG. 14 shows a rear perspective view with visible edges of the body assembled with the plate and partially shown lighting means according to the invention,

FIG. 15 shows a perspective view of another embodiment of the dock body,

FIG. 16 shows a front view of the embodiment of the dock body shown in FIG. 15,

FIG. 17 shows a cross section along AA of FIG. 16,

FIG. 18 shows a view of the rear face of the dock body shown in FIG. 15,

FIG. 19 shows a top view of the dock body shown in FIG. 15,

FIG. 20 shows a perspective view of another embodiment of the dock,

FIG. 21 shows a front view of the dock shown in FIG. 20,

FIG. 22 show a cross section along CC in FIG. 21,

FIG. 23 shows a view of the rear face of the dock shown in FIG. 20, and

FIG. 24 shows a top view of the dock shown in FIG. 20.

### DETAILED DESCRIPTION OF PREFERRED EMBODIMENTS

As explained previously, the dock according to the invention is able to receive a picture frame and affix it to a support, a wall for example, without the need for any specific intervention.

The dock itself may be made of any type of material, wood, metal, alloy, plastic, composite or any other material. For a plastic material, the dock is made, for example, by molding or rotomoulding. According to the invention, one or several magnetic means are provided whose function is to hold the frame in a horizontal position and retention means are provided to prevent any downward vertical displacement of the frame. These two means combined ensure that the frame is perfectly positioned on the dock. One or several magnetic means thus form part of the dock and the frame has one or several complementary magnetic or ferromagnetic means cooperating with those of the dock.

According to the invention, using retention means provides for either one magnetic retention means or two magnetic retention means to be used. Indeed, the magnetic means on their own are not able to ensure that the frame is held in position. This is why the applicant has planned to combine the frame's being held in position and its physical retention by retention means. This combination offers the advantage of being very simple to enact whilst enabling frames of substantial mass to be accommodated. This structure enables the use of over-powerful magnets, whose magnetic field may be disruptive for the immediate environment, to be avoided.

Naturally, the dock is attached to the support, for example by bonding using double-sided tape or by using fastening screws.

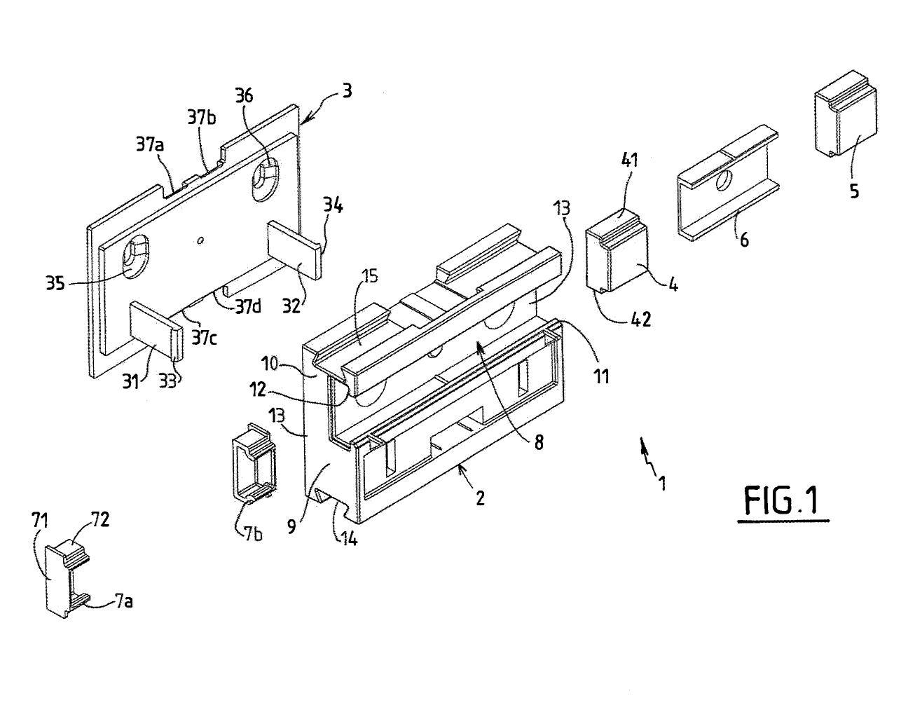

FIG. 1 shows an exploded view of a reception dock 1 formed mainly of a solid body 2 and a mounting plate 3 to affix it to the wall. The body 2 is substantially parallelepipedic in shape, and incorporates different machined elements as well as a U-shaped cage 8.

The cage 8 houses and holds in position the magnets 4 and 5, between which a spacer 6 has been inserted. This enables two magnetic zones to be created thereby facilitating the horizontal affixment of the frame 50 as will be explained hereafter. The free end of each branch 9, 10 of the U-shape is extended respectively by feet 11 and 12 parallel to the base of the U which is itself parallel to the bottom 13 of the body 2, thereby defining an open space, each of the branches 9, 10 being respectively provided with longitudinal groves 14, 15 opening outwards.

In the affixment position, groove 14 is oriented downwards and groove 15 upwards. It goes without saying that the bottom 13 of the U-shape is parallel with the rear face of the body 2 and that the branches 9 and 10 of the U, as well as the grooves 14 and 15, are parallel to one another.

During assembly, two retention caps 7a and 7b respectively for magnets 4 and 5 enable the cage 8 to be closed by wedging the magnets 4 and 5 against the spacer 6. Each cap 7a or 7b comprises a side 71 provided with a protrusion 72 intended to engage in the U-shape in the body 1.

The retention means are formed here by magnets 4 and 5. Each magnet 4, 5, as can be seen, is machined by milling at the intersection of two of these sides to delimit, at each end, two baseplates 41 and 42 intended to engage in the U in the body 2 and to be held in position by feet 11 and 12. These two magnets 4 and 5 are separated by the U-shaped spacer 6 intended to engage in the U in the body 2 and to be held in place by feet 11 and 12.

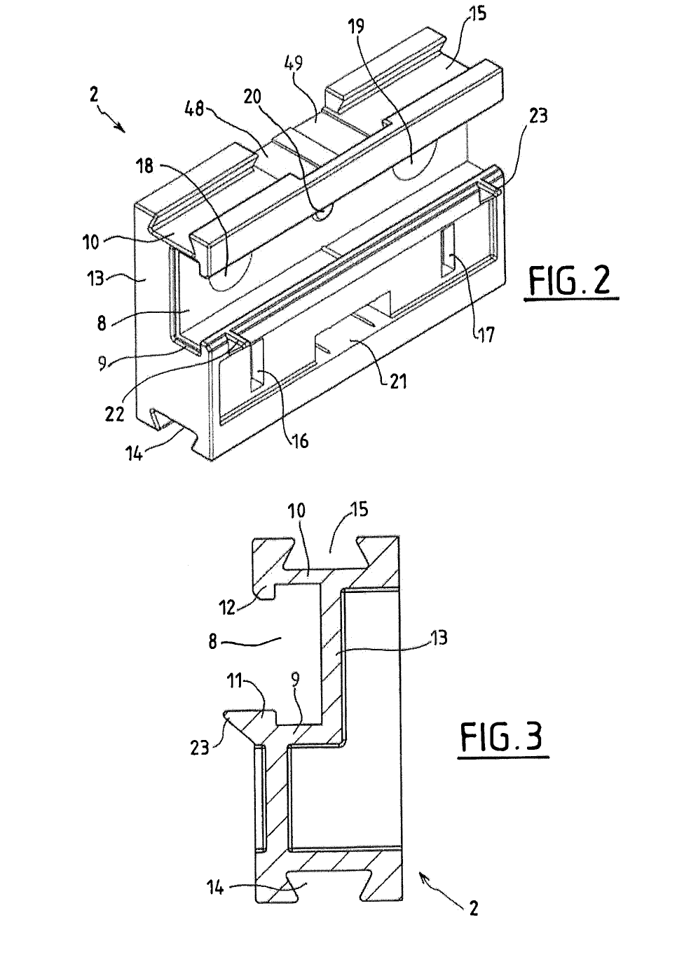

FIG. 2 shows a perspective view of the body 2 alone. The body 2 is provided with through slots 16 and 17, drill holes 18, 19 and 20 and a blind hole 21. The use of these elements will be explained later. The body 2 is provided with two lugs 22 and 23 at a distance from one another and protruding with respect to the branch 9 of the U-shape, on which the frame 50 will press as will be explained later. These two lugs 22 and 23 may be joined together to form a continuous support.

The body 2 is also provided with grooves 48 and 49 arranged perpendicularly to groove 15, and whose role will be explained later. Similar grooves (not shown here) are arranged in the opposing groove 14.

FIG. 3 shows a side section view via the retention means of the body 2 alone, highlighting the U-shape of the extrusion aforementioned with the bottom 13 and branches 9 and 10, the position of feet 11 and 12, and that of lug 23.

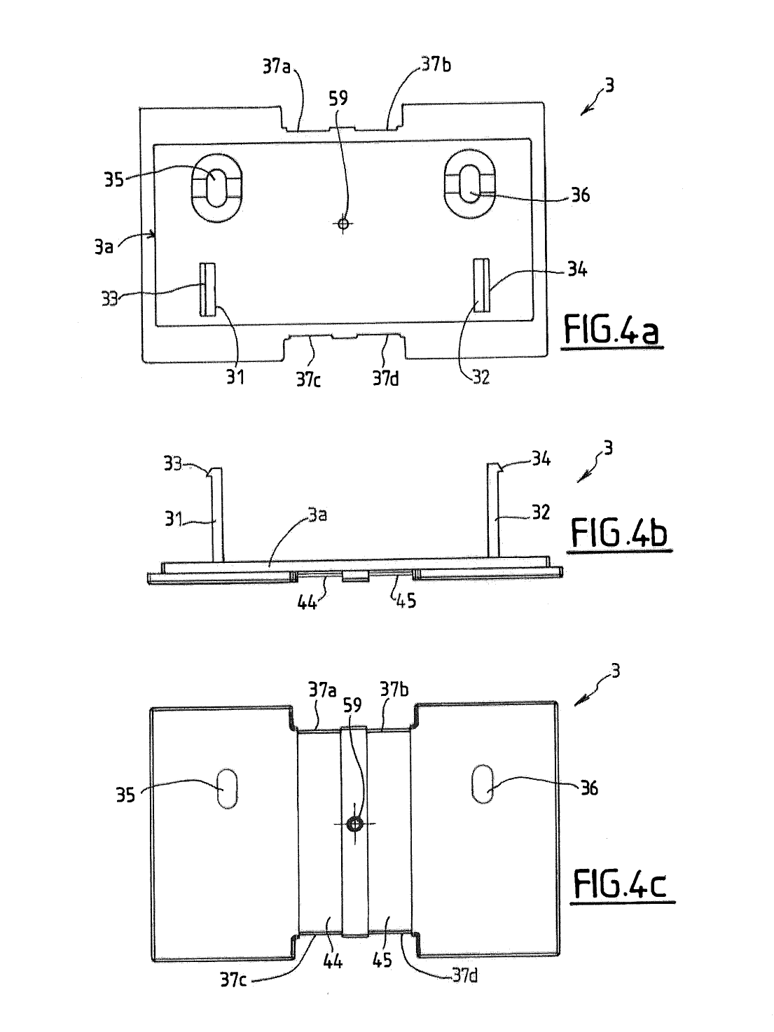

FIGS. 4a-4c show the manufacture of the mounting plate 3.

As can be seen in FIG. 4a which shows a front view of the plate 3, this plate 3 is substantially parallelepipedic and comprises two arms 31 and 32 intended to cooperate with through slots 16 and 17 of the body 2. Plate 3 is also provided with drill holes 35 and 36 respectively positioned so as to match with drill holes 18 and 19 when the plate 3 is linked to the body 2, namely allowing screws to be passed through to fasten it to the support.

The plate 3 is also provided with two indentations 37a and 37b in its upper part and two indentations 37c and 37d in its lower part and whose role will be explained later. Lastly, a through hole 9 can be seen in the centre of the plate 3, this hole 59 namely allowing a screw to be passed through so as to make the plate 3 truly integral with the body 2 thanks to the drill hole 20 whose position matches that of the through hole 59.

FIG. 4b is a top view of the mounting plate 3, highlighting the arms 31 and 32 and the claws 34 and 33. These two arms 31 and 32 end in claws 33 and 34 intended to hook onto the body 2 and penetrate slots 16 and 17. The plate 3 also incorporates two longitudinal ribs 44 and 45 whose role will be explained later. This plate can also be seen to be provided with an overmoulding 3a intended to perfect the positioning of the plate 3 on the body 2.

FIG. 4c is a rear view of the mounting plate 3 highlighting the two ribs 4 and 45 which extend respectively from indentation 37a to indentation 37c and from indentation 37b to indentation 37d.

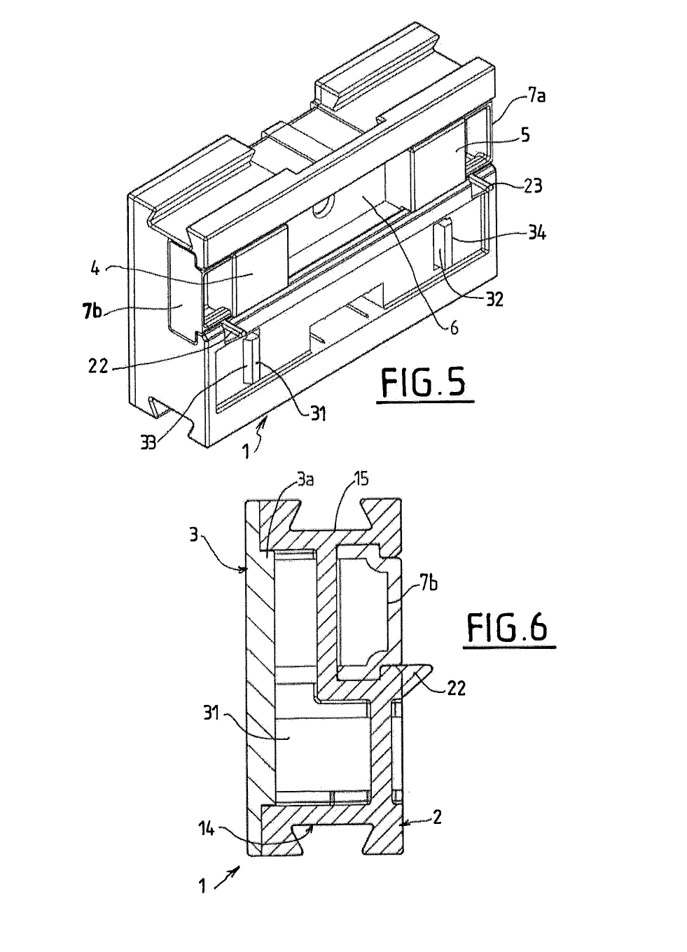

FIG. 5 shows the dock 1 equipped with its components. The spacer 6 is firstly introduced into the cage 8, then the magnets 4 and 5 on either side of the spacer, and lastly each cap 7a, 7b. The magnets 4 and 5 are wedged inside the U by means of the caps 7a and 7b and separated by the spacer 6. As can be seen, the claws 33 and 34 respectively on the ends of arms 31 and 32 of the plate 3 passing through slots 16 and 17 of the body clip the body 2 and plate 3 together.

FIG. 6 shows a section view of the dock 1 via one of the caps, for example cap 7b. The overmoulding 3a of the plate 3 can be seen to press in the body 2 preventing any relative displacement of this plate with respect to the body.

FIG. 7 shows a front view of the dock 1 fitted with the horizontal bar of a frame 50. Magnetic means 52 and 53 shown in dotted lines are provided in this frame. The frame 50 is thus held in place vertically by the lugs 22 and 23 onto which it presses and horizontally by the magnets 4 and 5. The frame 50 may be easily unhooked, for example, by raising one of its ends slightly upwards, thereby disconnecting the magnets 4, 5 from the matching magnets 52 and 53 in the frame 50, then by pulling the frame 50 upwards to remove it from the lugs 22 and 23 of the dock 1. The force of the magnets 4 and 5 may easily be adapted to the frame 50 that is to be affixed to the dock 1 depending on the mass of said frame.

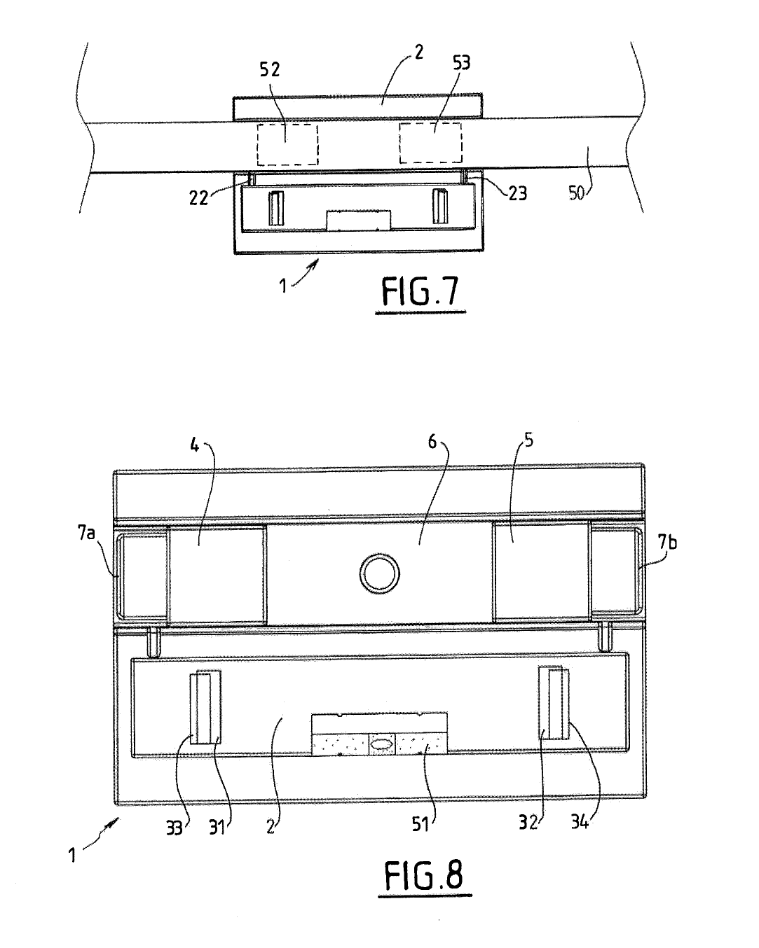

FIG. 8 shows a front view of the dock 1 equipped with a spirit level 51 located in the blind hole 21. The spirit level 51 allows the horizontal positioning of the dock 1 to be checked during its installation on its support. The position of the dock 6, magnets 4 and 5 and caps 7a and 7b can be seen. Claws 31 and 32 of arms 31 and 32 applied onto the body 2 can also be seen.

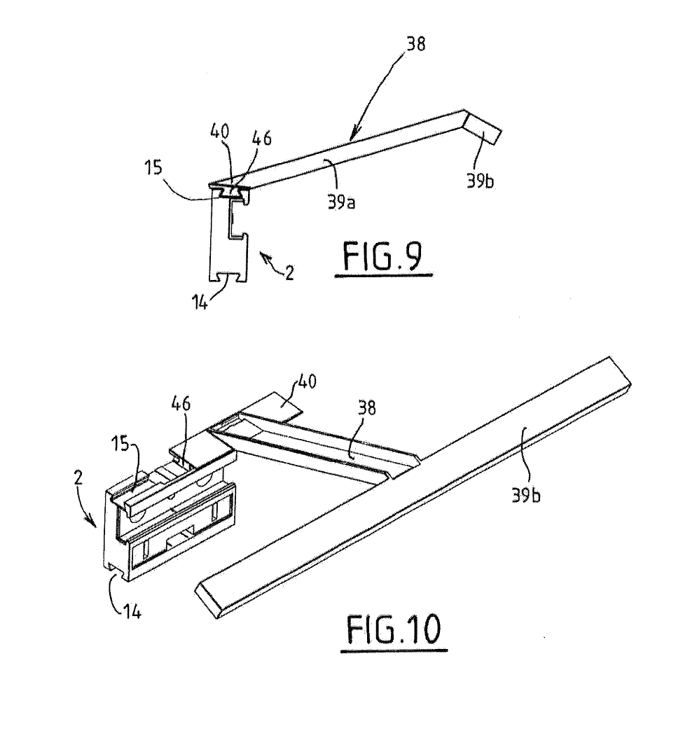

FIG. 9 shows a section view illustrating lighting means 38 for the frame affixed to the body 2. These means 38 comprise an arm 39a extended at its free end by a lighting device 39b and incorporating a male part 46 at its other end. As can be seen in the Figure, the lighting means 38 are engaged via the male part 46 in the groove 15 in the body 2 making a dovetail connection.

FIG. 10 shows a perspective view of the lighting means 38 partially assembled with the body 2. The male part 46 is partially engaged in the groove 15 and merely has to be fully engaged in order to fully integrate the lighting means and the dock.

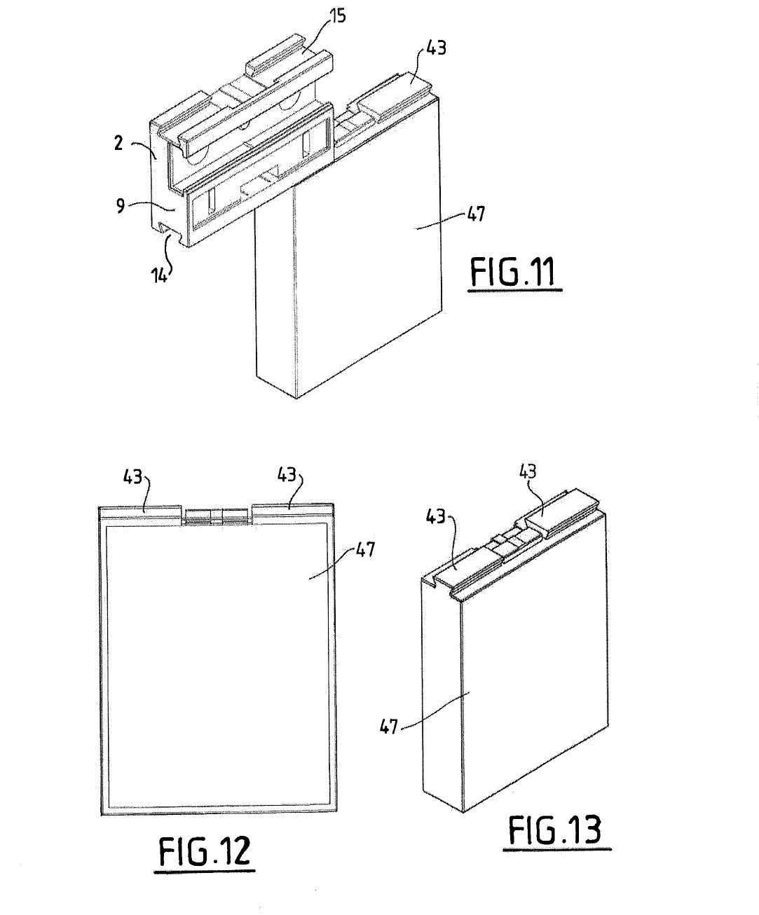

FIG. 11 shows an electrical energy supply 47 partially assembled with the body 2 and intended to supply the lighting means 38. This energy supply 47 is provided with a male part 43 intended to cooperate with the groove 14 in the body 2. FIG. 12 shows a front view of an energy supply 47 and FIG. 13 shows a perspective view of the energy supply 47.

It goes without saying that the two grooves 14 and 15 may be identical and thus that the positions of the energy supply 47 and the lighting means 38 may be swapped.

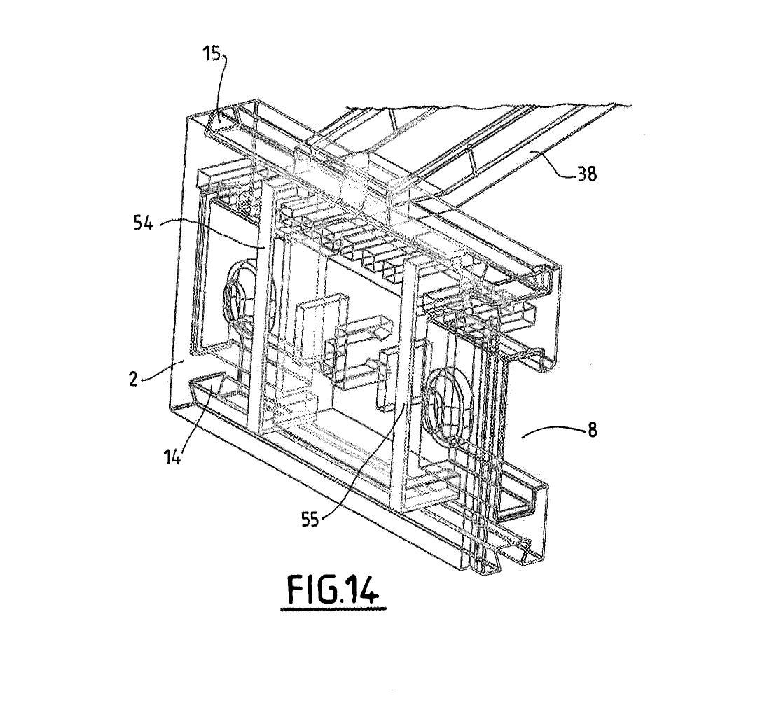

FIG. 14 shows a rear perspective view of the body 2 equipped with the lighting means 38 partly shown. To ensure the energy supply for the lighting means, there are two connectors 54 and 55 in the form of boards arranged respectively in ribs 44 and 45 of the body 2. These connectors 54 and 55 also respectively pass by grooves 48 and 49 (arranged perpendicularly to groove 15), as well as by the respective grooves not shown (arranged perpendicularly to groove 1).

The connectors arranged in the grooves 48 and 49 and in the grooves not shown respectively are arranged to correspond respectively with contact pads (located on the male part 46) of the lighting means 38 and contact pads (located on the male part 43) of the energy supply 47. These connectors 54 and 55 thus perform the electrical connection between the energy supply 47 and the lighting means 38. The energy supply 47, whose male part 43 is inserted into the groove 14, supplies the lighting means whose male part is inserted into the groove 15, via connectors 54 and 55.

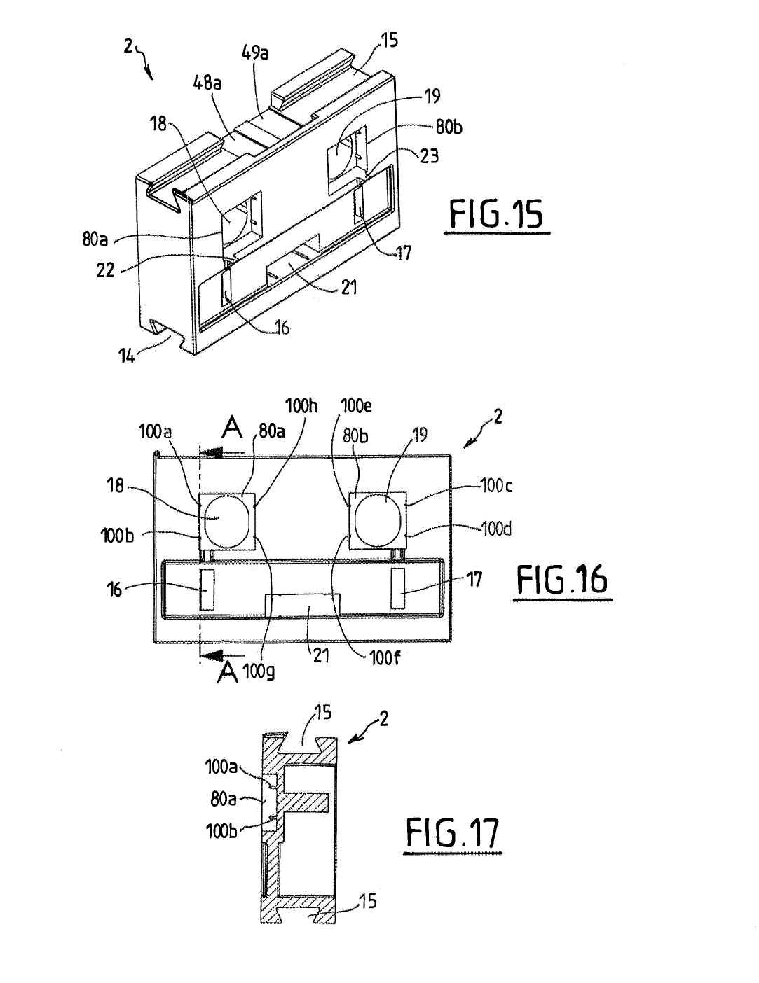

FIG. 15 shows a perspective view of a variant embodiment of the body 2. In this embodiment, two separate housings 80a and 80b are provided at a distance from one another, each intended to receive magnetic means, namely a magnet, which will be affixed to the body 2 by means of glue or clips. The grooves 15 and 14 are respectively located in the upper part and the lower part of the body 2.

The other machined elements do not differ from those in the embodiment of the body 2 shown in the previous Figures, namely the blind hole 21, the drill holes 18 and 19, the through slots 16 and 17, the lugs 22 and 23. Here the housings 80a and 80b can be seen to be in the prolongation of drill holes 18 and 19, which operationally enables the magnets to be bonded to the fore of the attachment screws via drill holes 18 and 19. The grooves 48a and 49a arranged perpendicularly to groove 15 are identical to grooves 48 and 49 in the body 2, shown in FIG. 2.

FIG. 16 is a front view of the body 2 of the dock 1 according to FIG. 15. The drill holes 18 and 19 can be seen to partially occupy the bottoms of housings 80a and 80b. Housings 80a and 80b are parallelepipedic in shape and the drill holes are cylindrical. Lastly, four raised surfaces 100a to 100h can be observed inside each of the housings 80a and 80b. The shape of the magnets (not shown here) is adapted to that of the housings 80a and 80b and thus incorporate grooves to match these raised surfaces 100a to 100h whose purpose is to guide the magnets into the housings 80a and 80b and hold them in place.

FIG. 17 is a section view, via the raised surfaces 100a and 100b of housing 80a, of the body 2 shown in FIG. 16. The lugs 22 and 23 cannot be seen in this view because of the angle of the section.

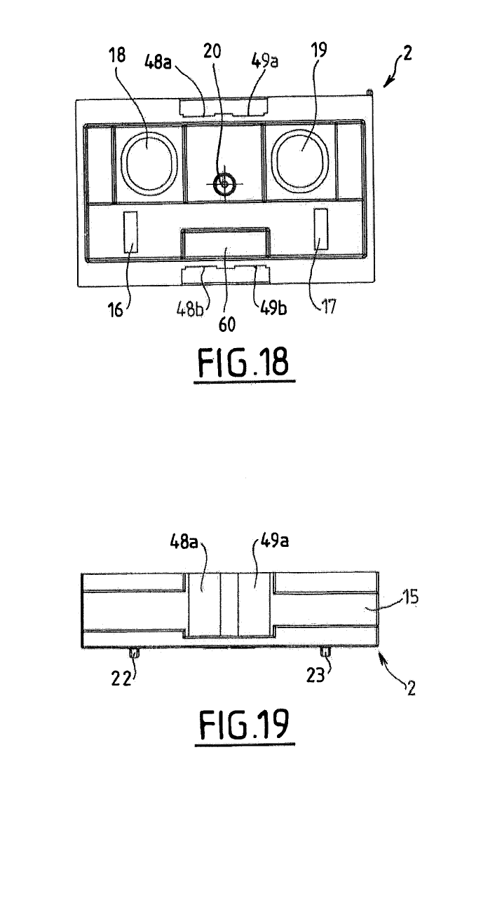

FIG. 18 shows a view of the rear face of the body 2 of the dock 1 shown in FIG. 15. The drill holes 18, 19 and 20 can be seen as can the slots 16 and 17. The grooves 48a and 49a can be seen as can the grooves 48a and 49b arranged perpendicularly to the groove 14, for example 6 mm wide, enabling the electrical connectors to be positioned in them as seen in the first embodiment.

FIG. 19 shows a top view of the body 2 of the dock 1 shown in FIG. 15, highlighting the lugs 22 and 23 protruding from the body and located at the base of the housings 80a and 80b. The lugs 22 and 23 here are separate and at a distance from one another.

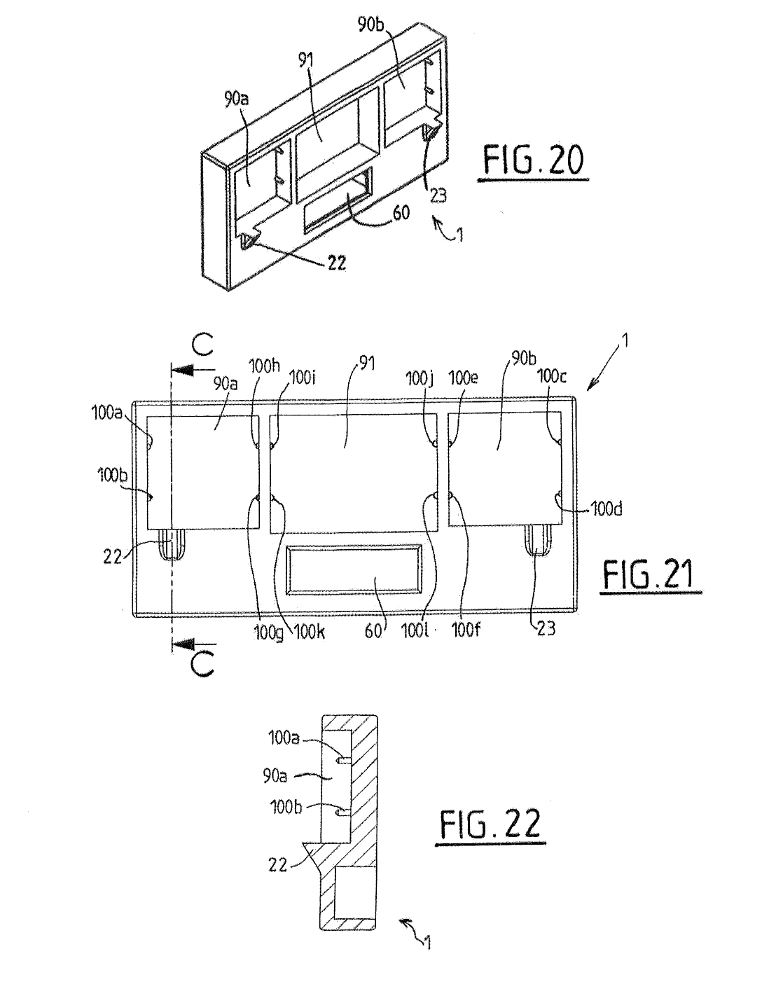

FIG. 20 shows a perspective view of another embodiment of the dock 1. This is generally substantially parallelepipedic in shape and is provided with three housings 90a, 90b and 91, the lateral housings 90a and 90b being close to each end and the housing 91 being located between the two housings 90a and 90b.

This embodiment may be used in two different ways. For example, a magnet may be placed, bonded or tightly fitted, into each of the lateral housings 90a, 90b and the frame 50 (not shown) affixed horizontally thanks to these two magnetic means. A magnet may also be bonded or tightly fitted into the central housing 91 and the frame 50 can thus be affixed by means of a single magnetic means. In both cases, the lugs 22 and 23, in the vicinity of the housings 90a and 90b act as vertical supports for the frame held in place by the magnetic means. The dock 1 here is of a single piece and is affixed to the support namely by means of a permanent, or possible reusable, adhesive. This makes the dock 1 extremely easy to use.

FIG. 21 shows a front view of the dock 1 shown in FIG. 20 and showing the housings and the lugs. The lateral housings 90a and 90b and central housing 91 also each incorporate four raised surfaces 100a-100l identical to those in the previous embodiment. Here there is no blind hole 21 but a drill hole 101 passing through the dock 1 and holding a spirit level.

FIG. 22 shows a section view along CC in FIG. 21 via the lug 22. The raised surfaces 100a and 100b can be seen in the housing 90a.

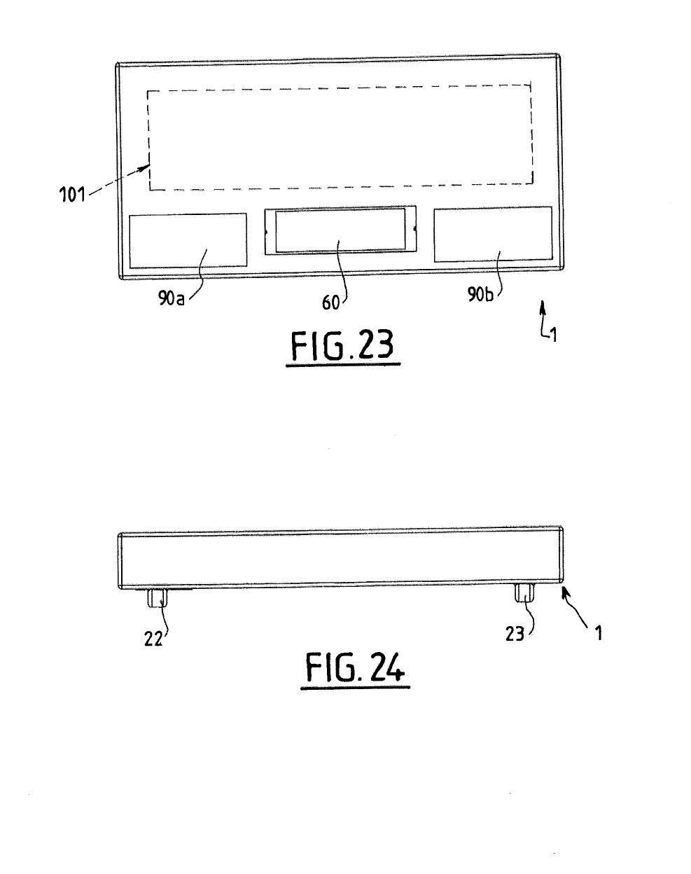

FIG. 23 shows a view of the rear face of the body of the dock 1 shown in FIG. 20. The indentation 101 across the dock 1 can also be seen. This rear face is intended to be affixed directly to the support, namely by bonding, by the surface 101 shown in dotted lines.

FIG. 24 shows a top view of the body of the dock shown in FIG. 20. This view highlights the lugs 22 and 23 protruding from the dock 1. The upper face of the dock can be seen to have no grooves. The same is true of its lower face.

It goes without saying that the force of the magnet or magnets is adapted to the characteristics of the picture.

What is claimed is:

1. A mounting dock to receive a display frame for a document or picture, able to be affixed to a support, wherein it comprises one or several magnetic means intended to hold the frame pressed to said dock in the horizontal position, and retention means intended to support the frame in the vertical position, said magnetic means being engaged in at least one housing made in the dock.

2. A mounting dock according to claim 1, wherein said retention means are constituted by two lugs protruding with respect to said dock, arranged substantially in the vicinity of said magnetic means and at a distance from one another.

3. A mounting dock according to claim 2, wherein it incorporates two housings intended to each house magnetic means.

4. A mounting dock according to claim 1, wherein it incorporates a housing in its central part intended to house magnetic means.

5. A mounting dock according to claim 2, wherein it is constituted by a solid body in which housings are made to accommodate said magnetic means and a plate to mount it on said support, said retention means protruding with respect to said body, said body and said plate being clipped and/or screwed together.

6. A mounting dock according to claim 5, wherein said body comprises two through slots, said mounting plate comprising two arms intended to cooperate with said though slots.

7. A mounting dock according to claim 6, wherein said arms end in claws to hook them to said body.

8. A mounting dock according to claim 5, wherein said body is in the form of a U-shaped extrusion delimiting a cage acting as a single housing for said magnetic means and of which the free end of each said branch is extended by feet parallel to the base of said U thereby defining an open space, each of said branches being provided with a longitudinal groove opening towards the exterior of said U.

9. A mounting dock according to claim 8, wherein said magnetic means are arranged in said U and held in position by said feet.

10. A mounting dock according to claim 9, wherein said magnetic means are constituted by two magnets kept at a distance from one another by a spacer.

11. A mounting dock according to claim 10, wherein each of said magnet is wedged against said spacer by means of a cap.

12. A mounting dock according to claim 8, wherein said retention means are constituted by two lugs protruding with respect to one of said branches.

13. A mounting dock according to claim 5, wherein it comprises:
lighting means comprising an arm extended at its free end by a lighting device and incorporating at its other end a male part intended to engage in the groove in one of said branches, and
an electrical energy supply equipped with a male part intended to cooperate with said groove in the other branch,
said electrical connection means being provided to link said lighting to said supply.

14. A mounting dock according to claim 13, wherein said connection means are in the form of a conductive wafer.

15. A mounting dock according to claim 5, wherein it is provided with a blind hole containing a spirit level to check the horizontal positioning of said dock.
